(19) United States
(12) Patent Application Publication
(10) Pub. No.: US 2014/0253981 A1
(43) Pub. Date: Sep. 11, 2014

(54) IMAGING APPARATUS AND BRIGHTNESS ADJUSTMENT METHOD

(71) Applicant: SEIKO EPSON CORPORATION, Tokyo (JP)

(72) Inventor: Yasunori YOSHINO, Matsumoto-Shi (JP)

(73) Assignee: SEIKO EPSON CORPORATION, Tokyo (JP)

(21) Appl. No.: 14/174,321

(22) Filed: Feb. 6, 2014

(30) Foreign Application Priority Data
Mar. 5, 2013 (JP) 2013-042841

(51) Int. Cl. H04N 1/024; H04N 1/028

(52) U.S. Cl. CPC H04N 1/02409; H04N 1/02815
USPC 358/475

(57) ABSTRACT

A document camera includes an imaging device, a focus lens to form an image of a subject on the imaging device, an illumination part to illuminate the subject, a focusing adjustment part to focus the image of the subject on the imaging device by moving the focus lens, and a brightness adjustment part to adjust brightness of illumination light of the illumination part based on a movement amount of the focus lens.

### BACKGROUND

1. Technical Field

The present invention relates to an imaging apparatus and a brightness adjustment method.

2. Related Art

Hitherto, a document camera as an imaging apparatus is known which is connected to an external equipment such as a projector or a PC (Personal Computer) and transmits an imaged image to the external equipment (see, for example, JP-A-2010-171761 (patent literature 1)).

The document camera disclosed in the patent literature 1 includes a main body part and an arm part attached to the main body part. A bottom part at a tip of the arm part is provided with a camera including an imaging device and a lens. In the document camera, the position of the camera relative to a subject can be moved by moving the arm part. The imaged image obtained by the camera as stated above is processed by a processing circuit provided in the main body part, and is transmitted to the external equipment.

When the surround luminance is insufficient, the ratio (amount) of noise in an output signal from the imaging device increases, and there is a case where an image intended by a user can not be obtained. Thus, a technique is known in which an illumination part to illuminate the subject is provided in the camera.

Here, since the illumination direction of the illumination part is directed to the center portion of an imaging area, the brightness of the center portion becomes relatively high. Thus, when the relative distance between the subject and the imaging device becomes short, the brightness of the center portion becomes more remarkably high, and consequently, there is a case where a clear imaged image can not be obtained.

### SUMMARY

An advantage of some aspects of the invention is to provide an imaging apparatus which can properly illuminate a subject and a brightness adjustment method.

An imaging apparatus according to a first aspect of the invention includes an imaging device, a focus lens to form an image of a subject on the imaging device, an illumination part to illuminate the subject, a focusing adjustment part to focus the image of the subject on the imaging device by moving the focus lens, and a brightness adjustment part to adjust brightness of illumination light of the illumination part based on a movement amount of the focus lens.

Here, a relative distance between the subject and the imaging device is correlated with the movement amount of the focus lens from a reference position in a focused state. Thus, the relative distance between the subject and the imaging device can be obtained based on the movement amount of the focus lens.

According to the first aspect, the brightness adjustment part adjusts the brightness of the illumination light of the illumination part based on the movement amount of the focus lens, so that the brightness of the illumination light can be adjusted to the brightness suitable for the relative distance between the subject and the imaging device. For example, when the relative distance between the subject and the imaging device is relatively short, the brightness adjustment part reduces the brightness of the illumination light. When the relative distance is long, the brightness adjustment part increases the brightness of the illumination light. Accordingly, the subject can be properly illuminated. As stated above, since the subject can be properly illuminated, a clear imaged image can be obtained.

In the first aspect, it is preferable that a storage part storing correspondence information indicating a correspondence relation between the movement amount of the focus lens and the brightness of the light of the illumination part is included, and the brightness adjustment part acquires brightness corresponding to the movement amount of the focus lens from the correspondence information and adjusts the brightness of the illumination light based on the acquired brightness.

According to this configuration, since the brightness corresponding to the movement amount of the focus lens is not required to be calculated, the processing load of the imaging apparatus to perform the brightness adjustment of the illumination light can be reduced.

In the first aspect, it is preferable that the storage part stores the correspondence information for a type of the subject, the imaging apparatus includes a selection part to select the correspondence information, and the brightness adjustment part adjusts the brightness of the illumination light based on the correspondence information selected by the selection part.

Here, the type of the subject is, for example, a classification based on material or color of the subject.

According to this configuration, the brightness adjustment part can adjust the brightness of the illumination light to the brightness suitable for the type of the subject. For example, when the subject is a paper having high optical reflectivity and the brightness of the illumination light is adjusted according to the type of the subject, the brightness of the illumination light can be adjusted to be low as compared with a case where the subject is a paper having low optical reflectivity, and the brightness adjustment can be performed according to the type of the subject. By this, the subject can be more properly illuminated, and a clearer imaged image can be obtained.

In the first aspect, it is preferable that the brightness adjustment part adjusts the brightness of the illumination light based on the movement amount and an imaging angle of view of the focus lens.

Incidentally, the imaging angle of view indicates the wideness of an imaging area when the imaged image is extracted, and indicates a zoom state.

According to this configuration, the subject can be more properly illuminated, and a clearer imaged image can be obtained.

In the first aspect, it is preferable that a plurality of the illumination parts are provided, and the brightness adjustment part adjusts the brightness of the illumination light by controlling the number of the illumination parts to be lit.

According to this configuration, an inexpensive light source having no adjustment function of emission brightness can be used as the illumination part, and the cost of the imaging apparatus can be reduced.

In the first aspect, it is preferable that when the subject is a three-dimensional object, the brightness adjustment part adjusts the brightness of the illumination light based on the movement amount of the focus lens when focusing is performed on a portion of the subject where a relative distance from the imaging device is shortest.

Here, when the subject is the three-dimensional object, if illumination light of high brightness is incident on the portion of the subject where the distance from the imaging device is shortest, the incident part of the illumination light is observed as a spot (area where the brightness is locally high) in the imaged image, and a clear imaged image may not be obtained. On the other hand, according to the above structure, since the brightness of the illumination light at the place where the spot is liable to be observed is adjusted, the subject can be properly illuminated, and the observation of the spot can be suppressed. By this, a clear imaged image can be obtained.

A brightness adjustment method according to a second aspect of the invention is performed by an imaging apparatus including an imaging device, a focus lens to form an image of a subject on the imaging device, and an illumination part to illuminate the subject and is for adjusting brightness of illumination light of the illumination part, and the method includes focusing the image of the subject on the imaging device by moving the focus lens, and adjusting the brightness of the illumination light based on a movement amount of the focus lens.

According to the second aspect, the imaging apparatus performs the brightness adjustment method, so that the same effects as those of the first aspect can be obtained.

### BRIEF DESCRIPTION OF THE DRAWINGS

The invention will be described with reference to the accompanying drawings, wherein like numbers reference like elements.

FIG. 1 is a perspective view showing a document camera of an embodiment of the invention.

FIG. 2 is a perspective view showing the document camera of the embodiment.

FIG. 3 is a perspective view showing a lower case of the embodiment.

FIG. 4 is a block diagram showing an inner structure of the document camera of the embodiment.

### DESCRIPTION OF EXEMPLARY EMBODIMENTS

Hereinafter, an embodiment of the invention will be described with reference to the drawings.

### Rough Structure of Document Camera

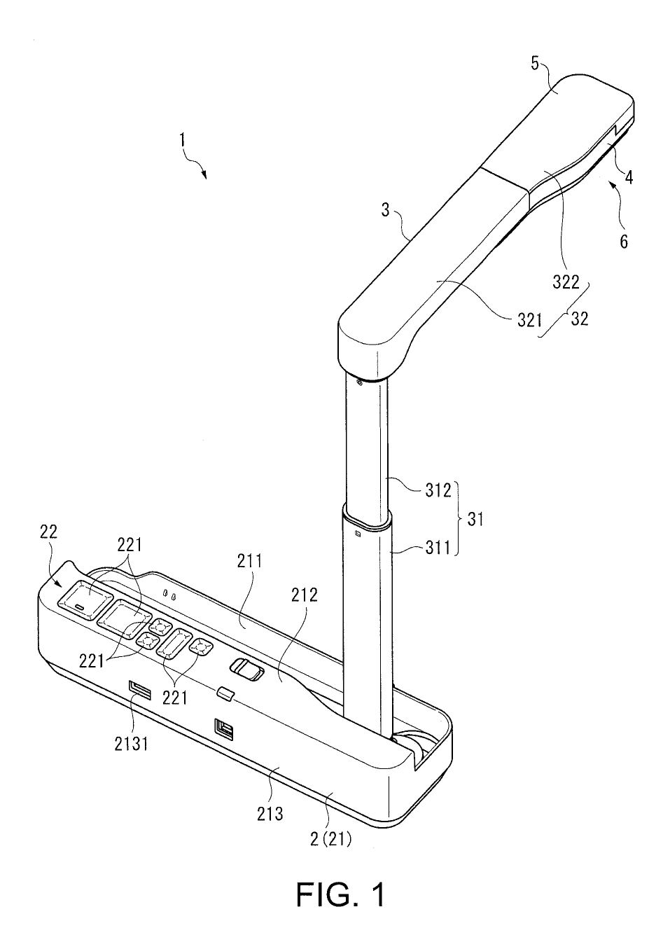

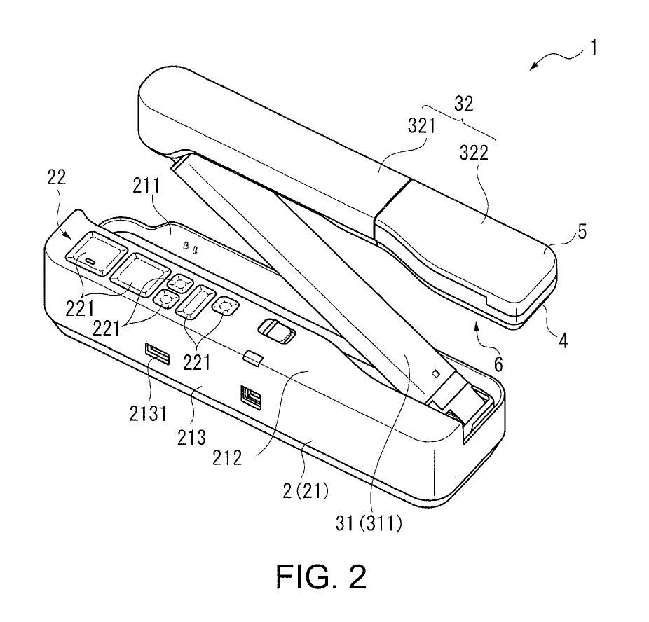

FIG. 1 and FIG. 2 are perspective views showing a document camera 1 of the embodiment. Particularly, FIG. 1 is a perspective view showing the document camera 1 in a use state, and FIG. 2 is a perspective view showing the document camera 1 in a housed state.

The document camera 1 of this embodiment is an imaging apparatus to transmit an imaged image to an external equipment such as a projector or a PC. As shown in FIG. 1 and FIG. 2, the document camera 1 includes a main body part 2 and a support part 3 provided on the main body part 2.

### Structure of the Main Body Part

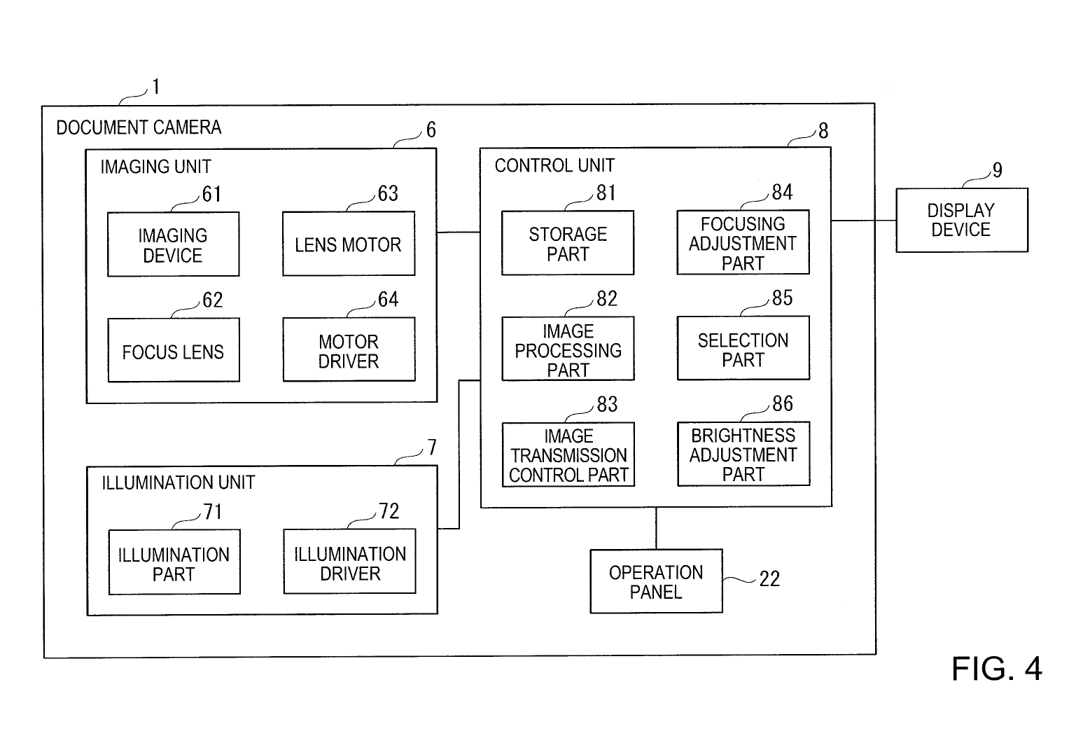

The main body part 2 includes a housing 21 formed of a synthetic resin into a substantially rectangular parallelpiped shape, and a control unit 8 (see FIG. 4) to control the document camera 1 is provided in the housing 21.

The housing 21 is provided with a concave part 211 opening upward.

Besides, a top surface 212 of the housing 21 is provided with an operation panel 22 as an operation unit on which plural keys 221 are arranged. The operation panel 22 outputs a control signal corresponding to the input operation of the keys 221 to the control unit 8. As the keys 221, an auto focus key, an imaging mode selection key, a standby key, a zoom key, an image quality adjustment key and the like are arranged.

Further, a terminal 2131 to which a video cable connected to the external equipment is connected is provided on a side surface 213 at an opposite side to the concave part 211 side in the housing 21.

### Structure of the Support Part

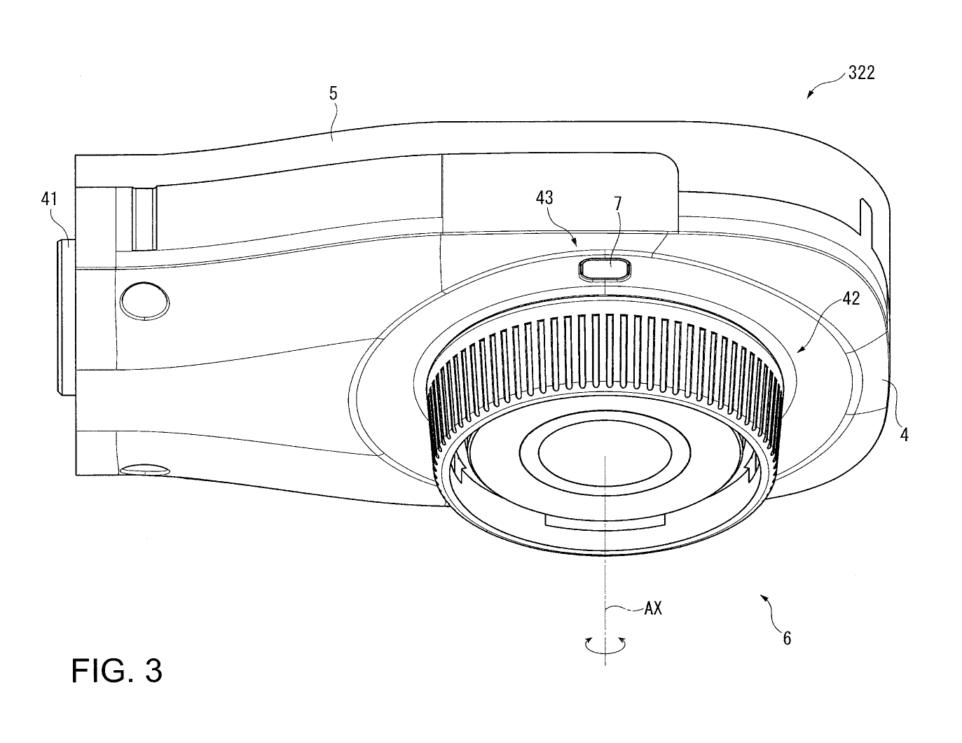

The support part 3 is for supporting an imaging unit 6 and an illumination unit 7 described later. When the document camera 1 is used, the support part 3 is pulled out as shown in FIG. 1, and when the document camera 1 is not used, the support part is folded and housed in the concave part 211 as shown in FIG. 2. The support part 3 includes a first arm 31 whose one end is bendably and rotatably attached in the concave part 211 of the housing 21, and a second arm 32 bendably and rotatably attached to the other end of the first arm 31. Incidentally, a cable to connect the control unit 8 to the imaging unit 6 and the illumination unit 7 (see FIG. 3) attached to the second arm 32 is provided in these arms 31 and 32.

The first arm 31 includes a first axial part 311 and a second axial part 312.

The first axial part 311 is supported at one end in a longitudinal direction in the concave part 211, can be freely bent relative to the concave part 211 and can be rotated around the center axis of the first arm 31. The second axial part 312 is provided inside the first axial part 311 and can be freely projected and inserted along the center axis of the first axial part 311. The first arm 31 is constructed of the respective axial parts 311 and 312 to be freely expandable and contractible.

The second arm 32 includes a rotation part 321 and a holding part 322 to hold the imaging unit 6 and the illumination unit 7.

The rotation part 321 is attached to a tip part of the second axial part 312 (an end part at the opposite side to the housing 21 side). The rotation part 321 is attached to be rotatable around the center axis of the second axial part 312 and to be freely bent in an orthogonal direction to the center axis.

The holding part 322 is supported at one end of the rotation part 321 opposite to the second axial part 312 side and can be freely rotated around the center axis of the second arm 32. The holding part 322 includes a lower case 4 which is positioned at a lower side when the holding part 322 is not rotated relative to the rotation part 321 and an upper case 5 which is positioned at an upper side and is combined with the lower case 4. These are fixed to each other by a screw (not shown). The structure of the lower case 4 will be described later in detail.

When the document camera 1 is used, as shown in FIG. 1, the first arm 31 is erected from the concave part 211 of the main body part 2, and the second arm 32 is rotated around the center axis of the first arm 31. Incidentally, when necessary, the second axial part 312 is made to project from the first axial part 311 so as to expand the first arm 31, or the holding part 322 of the second arm 32 is rotated, so that the imaging direction of the imaging unit 6 can be adjusted.

On the other hand, when the document camera 1 is not used, as shown in FIG. 2, in the state where the second axial part 312 is inserted in the first axial part 311, the first arm 31 is inclined into the concave part 211, and further, the second arm 32 is bent so as to be laid along the first arm 31. By this, the support part 3 is folded and housed in the concave part 211. At this time, the document camera 1 has a substantially rectangular parallelepiped shape.

### Structure of the Lower Case

FIG. 3 is a perspective view in which the lower case 4 is seen from a lower direction (opposite side to the upper case 5). Incidentally, in the following description, the lower direction indicates a direction in which the lower case 4 is positioned relative to the upper case 5, and an upper direction indicates a direction opposite to the lower direction.

As shown in FIG. 3, the lower case 4 is a support member which rotatably supports the imaging unit 6 and further supports the illumination unit 7 to illuminate an imaging object of the imaging unit 6. The lower case is formed into a substantially rectangular shape when viewed on a plane. As shown in FIG. 3, the lower case 4 includes an axial support part 41, an imaging unit support part 42 and an illumination unit attachment part 43.

The axial support part 41 is formed into a semi-cylindrical shape at an end of the lower case 4 on the rotation part 321 side. The axial support part 41 is combined with an axial support part (not shown) of the upper case 5 having the same structure as the axial support part 41 and is formed into a cylindrical shape. These axial support parts are attached to the rotation part 321. By this, the holding part 322 is axially supported to the rotation part 321.

The imaging unit support part 42 is provided in the lower case 4 on the opposite side to the axial support part 41 side, and supports the imaging unit 6 rotatably around the up-and-down direction.

A pair of the illumination unit attachment parts 43 are provided so as to hold the imaging unit support part 42. The illumination unit 7 is attached to each of the illumination unit attachment parts 43 in a state where the illumination direction is directed to the lower direction.

### Structure of the Imaging Unit

FIG. 4 is a block diagram showing a structure of the document camera 1. Incidentally, in FIG. 4, only the one illumination unit 7 is shown as a representative.

The imaging unit 6 is for outputting an image (imaged image) obtained by imaging an imaging area to the control unit 8 through the cable provided in the support part 32. As shown in FIG. 4, the imaging unit 6 includes an imaging device 61, a focus lens 62, a lens motor 63 and a motor driver 64.

The imaging device 61 is an imaging device such as a CCD (Charge Coupled Device) or a CMOS (Complementary Metal Oxide Semiconductor) device, and outputs the imaged image to the control unit 8. The imaging device 61 is arranged so that the imaging direction is directed to the lower direction.

Incidentally, the imaging unit 6 is supported in the lower case 4 rotatably around the optical axis of the imaging device 61. That is, as shown in FIG. 3, the imaging unit 6 is rotatable around a rotation axis AX coincident with the optical axis.

The focus lens 62 is a lens which moves forward and backward along the optical axis of the imaging device 61 and forms an image of a subject on the imaging device 61.

The lens motor 63 moves the focus lens 62. As the lens motor 63, a stepping motor can be adopted.

The motor driver 64 drives the lens motor 63 in accordance with a drive signal inputted from the control unit 8.

### Structure of the Illumination Unit

The illumination unit 7 is attached to each of the two illumination unit attachment parts 43, and illuminates the imaging area of the imaging unit 6. As shown in FIG. 4, the illumination unit 7 includes an illumination part 71 and an illumination driver 72.

The illumination part 71 is arranged so that the illumination direction is directed to the lower direction. As the illumination part 71, a solid light source such as an LED (Light Emitting Diode) can be exemplified.

The illumination driver 72 lights the illumination part 71 based on a control signal inputted from the control unit 8 through the cable provided in the support part 32.

### Structure of the Control Unit

Although a detailed illustration is omitted, the control unit 8 is constructed as a circuit board on which a CPU (Central Processing Unit) and a memory are mounted, and controls the operation of the document camera 1 autonomously or according to the operation of a user. As shown in FIG. 4, the control unit 8 includes a storage part 81 constructed as a part of the memory and further includes respective function parts indicated as an image processing part 82, an image transmission control part 83, a focusing adjustment part 84, a selection part 85 and a brightness adjustment part 86, which are realized by execution of a program stored in the memory by the CPU.

The image processing part 82 processes the imaged image inputted from the imaging device 61. Besides, the image processing part 82 generates menu screen data.

The image transmission control part 83 transmits image data of the imaged image processed by the image processing part 82 and the menu screen data generated by the image processing part 82 to a display device 9 as an external equipment connected through a video cable or the like.

When the auto focus key provided on the operation panel 22 is depressed, the focusing adjustment part 84 controls the motor driver 64 to rotate the lens motor 63, and moves the focus lens 62 so that the image of the subject is focused on the imaging device 61. Specifically, while the focus lens 62 is moved, the focusing adjustment part 84 detects a contrast value of the image data processed by the image processing part 82 for each frame, and stops the movement of the focus lens 62 at a point where the contrast value becomes maximum, so that the image of the subject is focused on the imaging device 61.

Incidentally, when the subject is a three-dimensional object and an operation (three-dimensional object imaging operation) to image the three-dimensional object is performed by the user, the focusing adjustment part 84 moves the focus lens 62, and a portion of the subject where the relative distance from the imaging device 61 is shortest is focused on the imaging device 61. Thereafter, the focusing adjustment part 84 moves the focus lens 62, and a previously set portion of the subject or a portion selected by the operation of the user is focused on the imaging device 61.

Incidentally, in this embodiment, since the lens motor 63 is constructed of the stepping motor, the movement amount of the focus lens 62 by the lens motor 63 can be acquired based on the number of pulses outputted to the lens motor 63 from the state where the focus lens 62 is positioned at a reference position.

The storage part 81 stores plural pieces of correspondence information indicating the correspondence relation between the movement amount of the focus lens 62 and the brightness of light emitted from the illumination part 71, which are set for each subject type. Here, the subject type is classified according to, for example, a material such as glossy paper or plain paper, color or the like.

The selection part 85 determines the subject type based on an imaging mode selected by the user through the imaging mode selection key provided on the operation panel 22. The selection part 85 selects one piece of correspondence information relating to the determination result from the plural pieces of correspondence information stored in the storage part 81.

Here, the imaging mode includes, for example, a text mode in which a document displayed on glossy paper is imaged and a moving picture mode in which a screen on which a moving picture is displayed is imaged. For example, when the text mode is selected, the selection part 85 determines that the subject is the glossy paper, and selects the correspondence information relating thereto.

Besides, the selection part 85 determines, for example, the color of the subject based on the image data processed by the image processing part 82, and may select the correspondence information relating to this color.

The brightness adjustment part 86 counts the pulse number of pulse signals outputted to the lens motor 63, and acquires the movement amount of the focus lens 62 based on the count number. Incidentally, when the three-dimensional object imaging operation is performed, the brightness adjustment part 86 acquires the movement amount of the focus lens 62 when focusing is performed on the portion of the subject where the relative distance from the imaging device 61 is shortest.

Besides, the brightness adjustment part 86 accesses the storage part 81, and acquires the brightness corresponding to the acquired movement amount from the correspondence information selected by the selection part 85.

Besides, the brightness adjustment part 86 controls the illumination driver 72, and adjusts the brightness of illumination light emitted from the illumination part 71 based on the brightness acquired from the correspondence information. Here, in this embodiment, although the brightness adjustment part 86 adjusts so that the brightnesses of the illumination lights emitted from the two illumination parts 71 are equal to each other, the brightnesses of the illumination lights may be individually adjusted.

### Operation of the Control Unit

When the auto focus key provided on the operation panel 22 is depressed, the focusing adjustment part 84 controls the motor driver 64, and moves the focus lens 62 so that the image of the subject is focused on the imaging device 61. At this time, the brightness adjustment part 86 counts the pulse number of the pulse signals outputted to the lens motor 63, and acquires the movement amount of the focus lens 62 based on the count number.

Next, the selection part 85 determines the type of the subject based on the imaging mode selected by the user through the imaging mode selection key provided on the operation panel 22, and selects one piece of correspondence information relating to the determination result from the plural pieces of correspondence information stored in the storage part 81.

Incidentally, when the user selects the imaging mode, the image transmission control part 83 transmits the menu screen data generated by the image processing part 82 to the display device 9. By this, the menu screen can be displayed by the display device 9. While seeing the menu screen, the user operates the imaging mode selection key and can select the imaging mode.

Next, the brightness adjustment part 86 accesses the storage part 81, and acquires the brightness corresponding to the acquired movement amount of the focus lens 62 from the correspondence information selected by the selection part 85.

Then, the brightness adjustment part 86 controls the illumination driver 72, and adjusts the brightness of the illumination light emitted from the illumination part 71 based on the brightness obtained from the correspondence information.

The document camera 1 of this embodiment described above has following effects.

The relative distance between the subject and the imaging device 61 has a correlation with the movement amount of the focus lens 62 from the reference position in the focused state. Thus, the relative distance between the subject and the imaging device 61 can be obtained based on the movement amount of the focus lens 62. In this embodiment, the brightness adjustment part 86 adjusts the brightness of the illumination light emitted from the illumination part 71 based on the movement amount of the focus lens 62, so that the brightness of the illumination light can be adjusted to the brightness suitable for the relative distance between the subject and the imaging device 61. For example, when the relative distance between the subject and the imaging device 61 is relatively short, the brightness adjustment part 86 reduces the brightness of the illumination light. When the relative distance is long, the brightness adjustment part increases the brightness of the illumination light. Accordingly, the subject can be properly illuminated. As described above, since the subject can be properly illuminated, a clear imaged image can be obtained.

The storage part 81 stores the correspondence information indicating the correspondence relation between the movement amount of the focus lens 62 and the brightness of the light emitted from the illumination part 71. The brightness adjustment part 86 acquires the brightness corresponding to the movement amount of the focus lens 62 from the correspondence information, and adjusts the brightness of the illumination light based on the acquired brightness. According to this, since the brightness corresponding to the movement amount of the focus lens 62 is not required to be calculated, the processing load of the document camera 1 to perform the brightness adjustment of the illumination light can be reduced.

The storage part 81 stores the plural pieces of correspondence information which are set for each subject type. The document camera 1 includes the selection part 85 to select the correspondence information. The brightness adjustment part 86 adjusts the brightness of the illumination light based on the correspondence information selected by the selection part 85. According to this, the brightness adjustment part 86 can adjust the brightness of the illumination light to the brightness suitable for the subject type. For example, the subject is a paper having a high optical reflectivity, and the brightness of the illumination light is adjusted according to the subject type, as compared with a paper having a low optical reflectivity, the brightness of the illumination light can be adjusted to be low, and the brightness adjustment can be performed according to the subject type. By this, the subject can be more properly illuminated, and a clearer imaged image can be obtained.

When the subject is a three-dimensional object, the brightness adjustment part 86 adjusts the brightness of the illumination light based on the movement amount of the focus lens 62 when focusing is performed on a portion of the subject where the relative distance from the imaging device 61 is shortest. Here, when the subject is a three-dimensional object, if the illumination light having high brightness is incident on the portion of the subject where the distance from the imaging device 61 is shortest, the incident part of the illumination light is observed as a spot (area where the brightness is locally high) in the imaged image, and a clear imaged image may not be obtained. On the other hand, according to the above structure, since the brightness of the illumination light at the portion where the spot is liable to be observed is adjusted, the subject can be properly illuminated, and the observation of the spot is suppressed. By this, a clear imaged image can be obtained.

### Modification of the Embodiment

The invention is not limited to the foregoing embodiment, and includes modifications, improvements and the like within the scope in which the object of the invention can be achieved.

In the above embodiment, although the brightness adjustment part 86 acquires the brightness corresponding to the movement amount of the focus lens 62 from the correspondence information, the invention is not limited to this. That is, the brightness adjustment part 86 may acquire the brightness corresponding to the movement amount and an imaging angle of view (zoom state) of the focus lens 62 from correspondence information. For example, in digital zoom, the imaging angle of view can be acquired by detecting the ratio of an area extracted as an imaged image from the imaging area of the imaging device 61. In the case of optical zoom, the imaging angle of view can be obtained by detecting the movement amount of the zoom lens. In this case, the corresponding information indicates the correspondence relation between the brightness and the movement amount and the imaging angle of view of the focus lens 62. According to this, the subject can be illuminated more properly, and a clearer imaged image can be obtained.

In the above embodiment, although the brightness adjustment part 86 acquires the brightness from the correspondence information stored in the storage part 81, the invention is not limited to this. That is, the brightness adjustment part 86 may calculate the brightness suitable for the illumination based on the movement amount of the focus lens 62.

In the above embodiment, although the imaging mode is selected, the invention is not limited to this. That is, the imaging mode may not be selected. In this case, the storage part 81 stores one piece of correspondence information.

In the above embodiment, although the illumination units 7 are provided at the two places, the invention is not limited to this. For example, one or three or more illumination units 7 may be provided. Incidentally, when the plural illumination units 7 are provided, the brightness of the total illumination light emitted from the illumination units 7 may be adjusted by controlling the number of the illumination units 7 to be lit. According to this, an inexpensive light source having no adjustment function of emission brightness can be used as the illumination unit 7, and the cost of the document camera 1 can be reduced.

In the above embodiment, although the brightness adjustment part 86 counts the pulse number of the pulse signals outputted to the lens motor 63, and acquires the movement amount of the focus lens 62 based on the count number, the invention is not limited to this. That is, the focusing adjustment part 84 stores the movement amount of the focus lens 62, and the brightness adjustment part 86 may acquire the movement amount from the focusing adjustment part 84.

In the above embodiment, although the stepping motor is adopted as the lens motor 63, and the movement amount of the focus lens 62 is acquired based on the pulse number outputted to the stepping motor, the invention is not limited to this. That is, as long as the focus lens 62 can be moved and the movement amount of the focus lens 62 can be acquired, another kind of motor may be adopted, and the movement amount of the focus lens 62 may be acquired by another method. For example, the rotation angle of the focus lens 62 is detected by a rotary encoder, and the movement amount of the focus lens 62 may be acquired based on the rotation angle. Alternatively, the movement amount of the focus lens 62 may be acquired by a linear encoder.

In the above embodiment, although the first arm 31 and the second arm 32 are used as the mechanism to change the imaging position of the imaging unit 6, the invention is not limited to this. For example, a pipe having flexibility capable of holding the posture after the imaging position is changed may be used instead of the first arm 31 and the second arm 32.

In the above embodiment, although the document camera 1 to transmit an imaged image to an external equipment is exemplified as the imaging apparatus, the invention is not limited to this. That is, the invention can be applied to an electronic equipment including a structure capable of adjusting a relative distance between a subject and an imaging unit.

In the above embodiment, although the brightness adjustment part 86 adjusts the brightness of the illumination light irradiated to the imaging area by directly adjusting the emission brightness of the illumination part 71, the invention is not limited to this. That is, the brightness of the illumination light emitted from the illumination part 71 may be reduced by another structure. For example, the brightness of the illumination light illuminating the imaging area may be adjusted by intervening filters by which the light transmittance is stepwisely increased or decreased. Alternatively, the brightness of the illumination light may be adjusted by using a liquid crystal panel. In these cases, the brightness of the illumination light emitted from the illumination part 71 and irradiated to the imaging area is adjusted by intervening the filters or driving the liquid crystal panel instead of the control of the illumination driver 72 or in addition to the control of the illumination driver 72.

In the above embodiment, when the three-dimensional object imaging operation is performed, although the brightness adjustment part 86 adjusts the brightness of the illumination light based on the movement amount of the focus lens 62 when focusing is performed on the portion of the subject where the relative distance from the imaging device 61 is shortest, the invention is not limited to this. That is, the brightness adjustment part 86 may adjust the brightness of the illumination light based on the movement amount of the focus lens 62 when focusing is performed on a portion where the relative distance from the imaging device 61 is shortest among plural selected portions of the subject. Besides, the brightness adjustment part 86 may adjust the brightness of the illumination light based on the movement amount of the focus lens 62 when focusing is performed on an arbitrary portion of the subject.

The invention can be used as an imaging apparatus and can be preferably used as, for example, an imaging apparatus including an illumination part to illuminate a subject.

### CROSS REFERENCE TO RELATED APPLICATIONS

This application claims priority to Japanese Patent Application No. 2013-042841 filed on Mar. 5, 2013, the entire contents of which are incorporated by reference herein.

What is claimed is:

1. An imaging apparatus comprising:
an imaging device;
a focus lens to form an image of a subject on the imaging device;
an illumination part to illuminate the subject;
a focusing adjustment part to focus the image of the subject on the imaging device by moving the focus lens; and
a brightness adjustment part to adjust brightness of illumination light of the illumination part based on a movement amount of the focus lens.

2. The imaging apparatus according to claim 1, further comprising a storage part storing correspondence information indicating a correspondence relation between the movement amount of the focus lens and the brightness of the light of the illumination part, wherein
the brightness adjustment part acquires brightness corresponding to the movement amount of the focus lens from the correspondence information, and adjusts the brightness of the illumination light based on the acquired brightness.

3. The imaging apparatus according to claim 2, wherein
the storage part stores the correspondence information for each type of the subject,
the imaging apparatus includes a selection part to select the correspondence information, and
the brightness adjustment part adjusts the brightness of the illumination light based on the correspondence information selected by the selection part.

4. The imaging apparatus according to claim 1, wherein
the brightness adjustment part adjusts the brightness of the illumination light based on the movement amount and an imaging angle of view of the focus lens.

5. The imaging apparatus according to claim 1, wherein
a plurality of the illumination parts are provided, and
the brightness adjustment part adjusts the brightness of the illumination light by controlling the number of the illumination parts to be lit.

6. The imaging apparatus according to claim 1, wherein
when the subject is a three-dimensional object, the brightness adjustment part adjusts the brightness of the illumination light based on the movement amount of the focus lens when focusing is performed on a portion of the subject where a relative distance from the imaging device is shortest.

7. A brightness adjustment method which is performed by an imaging apparatus including an imaging device, a focus lens to form an image of a subject on the imaging device, and an illumination part to illuminate the subject and is for adjusting brightness of illumination light of the illumination part, the method comprising:
focusing the image of the subject on the imaging device by moving the focus lens; and
adjusting the brightness of the illumination light based on a movement amount of the focus lens.
